(19) United States
(12) Patent Application Publication
(10) Pub. No.: US 2015/0317653 A1
(43) Pub. Date: Nov. 5, 2015

(54) OMNI-CHANNEL DEMAND MODELING AND PRICE OPTIMIZATION

(71) Applicant: International Business Machines Corporation, Armonk, NY (US)

(72) Inventors: Markus R. Ettl, Ossining, NY (US); Pavithra Harsha, Yorktown Heights, NY (US); Tze Chao Ng, Union City, CA (US); Shivaram Subramanian, Danbury, CT (US)

(73) Assignee: INTERNATIONAL BUSINESS MACHINES CORPORATION, Armonk, NY (US)

(21) Appl. No.: 14/266,297

(22) Filed: Apr. 30, 2014

(51) Int. Cl. G06Q 30/02

(52) U.S. Cl. CPC G06Q 30/0205; G06Q 30/0202; G06Q 30/0206; G06Q 30/0201

(57) ABSTRACT

Predicting demand of a product offered in multiple channels for a seller that has a plurality of physical store channels and one or more virtual channels, may comprise obtaining transaction log data having records of sales transactions with location identifiers in the one or more virtual channels. The one or more virtual channels may be segmented by locations based on locations of the physical stores and the location identifiers in the transaction log data. A demand model may be estimated by location that incorporates demand for the multiple channels in that location and captures cross-effect of said multiple channels in the same location based on historic sales and transaction data. Integrated price optimization may be performed across all channels and locations that compute one or more prices for each virtual channel and one price for each location in the other channels while also satisfying a plurality of inter-channel and inter-locations constraints.

### FIELD

The present application relates generally to computers, and computer applications, and more particularly to a computer-implemented omni-channel demand modeling and price optimization.

### BACKGROUND

In current retail environment, consumers are increasingly navigating through multiple channels, even simultaneously, to make purchases. With smart phones, consumers at a brick and mortar store can visit the online and the social networking storefront of the same retailer and also its competitors to finalize a transaction. Omni-channel retailing is all about a seamless customer experience across all possible touch points, including stores, catalog, online, mobile and social. It entails a true customer-centric integration of the different channels.

Over the past several decades, retailers have employed sophisticated methodologies, and tools to better forecast demand and optimize their pricing and inventory management strategies to increase profitability in their businesses. Nevertheless, they operate their channels independent of each other in silos with little transparency even within an organization. They have primarily focused on physical stores and often treat their online store as yet another brick store even though online store geographically connect all the brick stores.

Recent statistics points to the accelerated growth rate in e-commerce, mobile and social commerce, compared to nearly flat growth rate in brick and mortar stores. In the present disclosure in one embodiment, new strategies for demand modeling and price optimization are provided that may cover the growing e-commerce sector as well as the physical stores (brick and mortar stores).

### BRIEF SUMMARY

A method of predicting demand of a product offered in multiple channels for a seller that has a plurality of physical store channels and one or more virtual channels, in one aspect, may comprise obtaining transaction log data associated with the one or more virtual channels. The transaction log data has records of sales transactions with location identifiers in the one or more virtual channels. The method may also comprise segmenting the one or more virtual channels by locations based on locations of the physical stores and the location identifiers in the transaction log data. The method may further comprise estimating a demand model by location that incorporates demand for the multiple channels in that location and captures cross-effect of said multiple channels in the location based on historic sales and transaction data, the location being one of the locations.

The method in another aspect may comprise computing cross-channel elasticity between the multiple channels in the location based on the estimated demand model, determining whether the location is a candidate for integrated price optimization based on the cross-channel elasticity, and in response to determining that the location is a candidate for integrated price optimization, adding the location to a set of candidate locations for joint price optimization.

In another aspect, the estimating a demand model, the computing cross-channel elasticity, and the determining whether the location is a candidate, are performed for every segmented location, and the method further may comprise jointly determining prices for the product by channel across all candidate locations.

A system for predicting demand of a product offered in multiple channels for a seller that has a plurality of physical store channels and one or more virtual channels, in one aspect, may comprise a processor and a memory device. A module may be operable to execute on the processor and obtain from the memory device, transaction log data associated with the one or more virtual channels, the transaction log data having records of sales transactions with location identifiers in the one or more virtual channels. The module may be further operable to segment the one or more virtual channels by locations based on locations of the physical stores and the location identifiers in the transaction log data. The module may be further operable to estimate a demand model that incorporates the multiple channels and captures cross-effect of said multiple channels for a location of the locations based on historic sales and transaction data.

In another aspect, the module may be further operable to compute cross-channel elasticity between the multiple channels in the location based on the estimated demand model, determine whether the location is a candidate for integrated price optimization based on the cross-channel elasticity, and in response to determining that the location is a candidate for integrated price optimization, add the location to a set of candidate locations for joint price optimization.

Yet in another aspect, the module may estimate the demand model, compute the cross-channel elasticity, and determine whether the location is a candidate, for every segmented location, and the module may further jointly determine prices for the product by channel across all candidate locations.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 shows an omni-channel retail analytics framework in one embodiment of the present disclosure.

FIG. 2 shows a cascading elasticity network in one embodiment of the present disclosure.

FIG. 3 is a flow diagram illustrating a methodology of the present disclosure in one embodiment.

FIG. 4 is another flow diagram illustrating a method of omni-channel pricing optimization in one embodiment of the present disclosure.

FIG. 5 illustrates a schematic of an example computer or processing system that may implement an omni-channel price optimization system in one embodiment of the present disclosure.

FIG. 6 shows an example plot of an instance of the OCP objective with attraction demand models for the case of a single virtual channel, e.g., online, and two locations.

### DETAILED DESCRIPTION

In one aspect of the present disclosure, an omni-channel demand modeling framework may be provided that models the behavior of consumers in an e-commerce and physical store environment. Examples of e-commerce stores (also referred to as virtual stores) may include those that allow purchases to be made through a mobile phone or device (e.g., via a mobile application), purchases made through social network stores, as well as Internet on-line stores operate via World Wide Web (web) sites. Those stores are referred to herein as virtual stores or virtual channels. In particular, this method accurately quantifies the cross interactions between different channels. An integrated decision making may be performed across the retail chain. A method for omni-channel pricing of basic hardline products is provided. In particular in one embodiment of the present disclosure, an integrated price optimization method across the retail chain that maximizes the retailers profitability is provided that accurately takes into account cross channel effects and therefore indirectly also minimizes lost-sales.

In existing demand modeling approaches, retailers gather sales data for the online store and brick stores along with the associated historical values of the demand drivers (attributes) such as price, promotion, seasonality, holiday etc., and estimate a demand model for each store as a function of various attributes independent of other stores and channels. In particular, they treat the online channel as yet another physical (brick and mortar) store. This separation by channel goes beyond demand modeling, and is visible in the organizational division, wherein channel-specific forecasting and optimization teams operate largely independent of each other. Consider the present day omni-channel consumer who navigates across channels including competition to make purchasing decisions. Sales data by store restricts attempts to accurately quantify these consumer interactions across channels, let alone competition. For example, it is easy to identify the effect of the online price on brick and mortar store sales at each physical location but practically impossible to identify the impact of all brick and mortar store prices on online sales because of the number of physical locations and prices varying by location. Mathematically, one can estimate the demand at location Bⱼ denoted by D_{B}_{ⱼ} (pₒ, p_{B}_{ⱼ}) where pₒ is the online price and p_{B}_{ⱼ} is the brick price at location Bⱼ whereas it is not easy to estimate the online demand denoted by Dₒ(pₒ, p_{B}_{₁}, p_{B}_{₂}, . . . ). Whereas using an average or a weighted average of brick prices does simplify the estimation procedure, it unfortunately also dilutes the accurate quantification of the cross-channel interactions. The same estimation issue arises for other attributes of demand beyond price, which can possibly vary by location. For example, consider the effect of running different promotions (discounts, advertisements, catalogs) in different locations or the effect of local competition. The inability to quantify the interactions correctly would result in sub-optimal solutions to omni-channel pricing and inventory management problems.

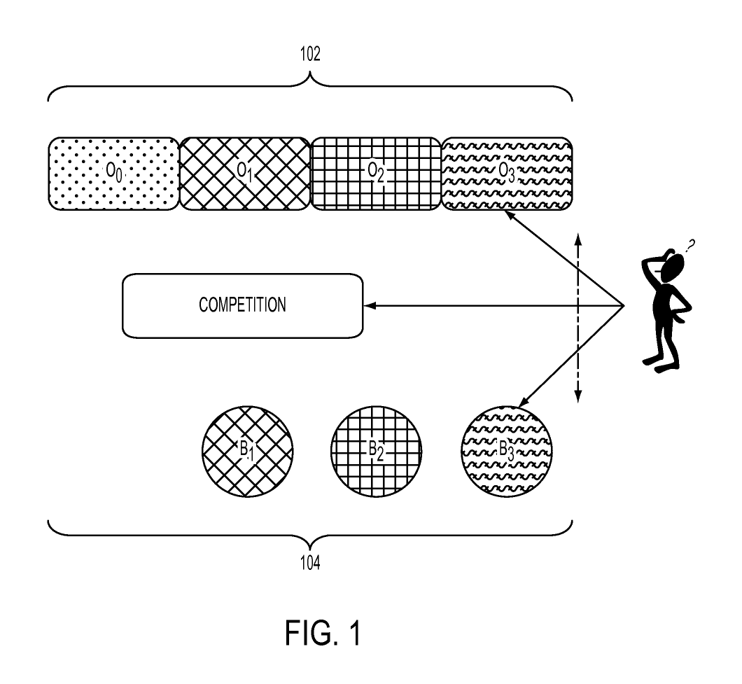

FIG. 1 shows an omni-channel retail analytics framework in one embodiment of the present disclosure. Example online store is divided into virtual stores with billing information, e.g., at 102. Example brick and mortar (physical) stores are shown at 104. A demand modeling framework is disclosed for the omni-channel environment to accurately quantify cross-channel interactions. In this framework, the online store is divided into multiple virtual online stores, e.g., by mapping the zipcode in every online transaction to nearby physical stores. Transactions that cannot be mapped to a physical store in the vicinity are grouped into a virtual store that is denoted with Oₒ in the figure.

In one aspect, creating these virtual online stores allows for the following:

1. The demand estimation problem for the online virtual stores is a local problem. For example, from a pricing point of view, the demand at virtual store O₃ is Dₒ_{₃} (pₒ_{₃}, p_{B}_{₃}). Here it is assumed that different geographical locations have little interactions from a consumer demand perspective. Therefore, the total online demand is the sum of demand from the online virtual stores.
2. The demand model estimated can easily take into account cross-interactions between channels and caters well in modeling consumer behavior in an omni-channel environment. In doing so, the demographic heterogeneity of the population shopping online is automatically incorporated and any further consumer segmentation idea is incorporated by recursively creating virtual stores.
3. Incorporating the effect of competition in demand modeling is more important than ever in an omni-channel environment. Because of (1) and (2), it is easy to incorporate the effects of local events and local competition even on online sales. Online competition is easy to incorporate because most of the time there is no competitive sales data and so there is no task of partitioning that data. Competitive prices, if available and if legal to use, are introduced as attributes and sometimes even choices to account for lost sales.
4. Despite the break up in sales data, the data requirements are still anonymous and roughly the same size as the brick data, important features for a retail software solution provider, e.g., to keep anonymity of transaction details.

In scenarios with sparse online virtual store data, one has to identify the right level in the location hierarchy of the retailer (e.g., zonal level, where zone is defined as a cluster of stores with some common factors) to achieve a good balance between model richness and forecast accuracy. There are a few challenges in creating the virtual stores. First, each transaction is associated with more than one zipcode such as a billing zipcode and a shipping zipcode. The billing zipcode has the advantage that it can be used to model the buyers behavior as opposed to the receiver in the event of a gift shipment. Second, multiple stores can cater to the same zipcode and imputing the virtual online transaction data by physical store is not an easy problem. The idea here is to cluster physical stores that result in minimal cross-talk between clusters and work at the cluster level. This clustering problem may be managed using prior art clustering methods such as k-means algorithm. With a more accurate characterization of demand through the omni-channel framework, a methodology of the present disclosure in one embodiment may solve for omni-channel pricing and inventory management.

Thus, in the present disclosure, products for integrated price optimization may be identified. Unobserved location specific virtual channel sales may be imputed from omni-channel TLOG data and location specific cross-channel effect may be estimated. The estimated cross-channel effect may be used to identify products for price optimization. Furthermore, integrated omni-channel price optimization may be performed across all locations and channels toto take into account the cascading cross channel price effects across locations and channels.

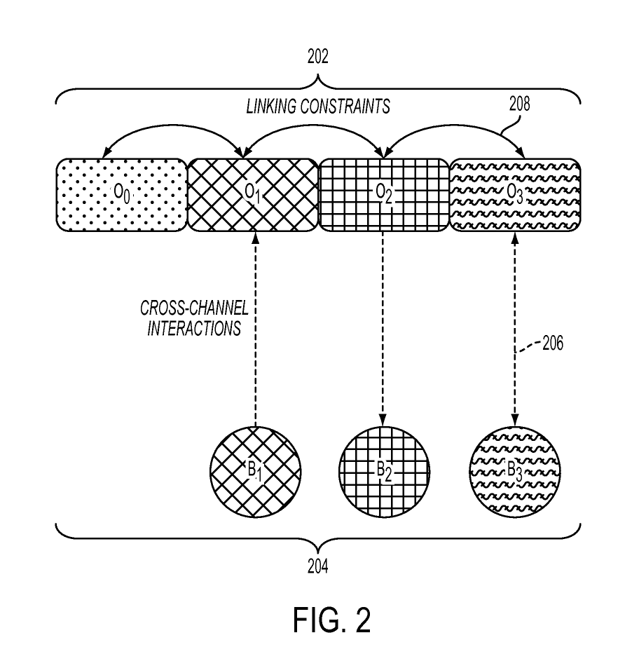

FIG. 2 shows a cascading elasticity network in one embodiment of the present disclosure. Example online store divided into virtual stores is shown at 202. Example brick and mortar (physical) stores are shown at 204. The cross-channel interactions (cross-effects across channels) shown as dashed lines (e.g., 206) and linking constraints across locations (linking constraints across virtual online stores) shown as double solid lines (e.g., 208) (such as a common price across virtual stores, capacity constraints in the online warehouse) result in a cascading price-elasticity networks. For such omni-channel environment, e.g., a methodology is provided that may integrate pricing decisions across all channels and locations, as well as for joint pricing and inventory management decisions. Integrated optimization, e.g., can handle inter-channel constraints; inter-zone constraints; shipping tiers; and competitive price effects in every channel and location.

Some of the benefits of integrated decision making across the retail chain are as follows: (1) it minimizes cross channel cannibalization and lost sales to competitors; (2) it better manages inventory costs across the retail chain by appropriate inventory allocations in general and more specifically when one models and incorporates newer omni-channel retailing features such as buy online pick-up in store; (3) it is easy to impose many inter-channel and inter-location constraints such as (price-matching or price monotonicity between channels or zones, sales goals across locations or channels) which are of practical importance; and, (4) the idea extends easily to more than two channels or shipping tiers. The challenge in solving an integrated optimization problem across the retail chain is the complexity and scalability of these problems in the channel and location dimensions. Reformulation and decomposition techniques of the present disclosure in one embodiment help overcome this challenge for a specific pricing problem: single product pricing with a focus on basic hardline product. With the plethora of retail data being collected including that of the competition and the massive strides made in large-scale optimization, discrete optimization and optimization engines over the recent years, such advances in revenue management would aid retailer to develop an edge in a competitive environment. The creation of the virtual stores and an integrated operation across the retail chain clearly makes the retailer's decision problems more customer centric rather than business or operations centric in the pastin omni-channel retail analytics.

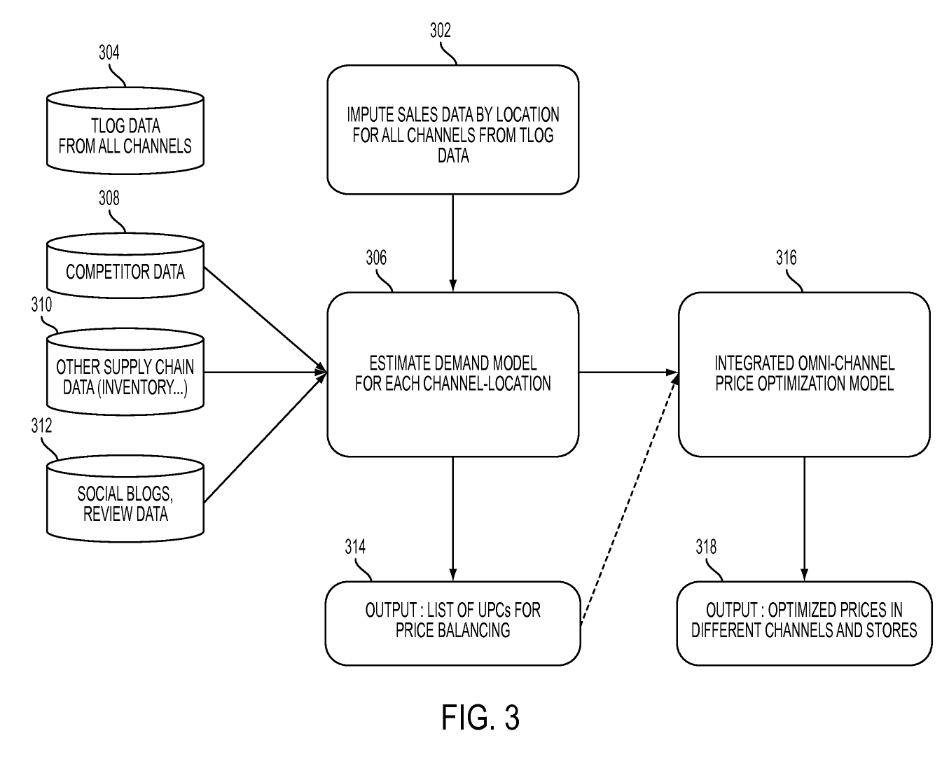

FIG. 3 is a flow diagram illustrating a methodology of the present disclosure in one embodiment. At 302, sales data is imputed by location for all channels from a transaction log (TLOG) data 304, for example stored in a storage device. For instance, as described above, sales data from online stores are divided into multiple virtual online stores/zones that correspond to physical stores/zones, if any, (e.g., shown at 102 in FIG. 1), e.g., using location identifiers such as zipcodes in every online transaction. For example, a virtual store or zone for every physical store or zone is created from the online transaction data which has location identifiers such as zip codes.

At 306, a demand model is estimated for each channel-location based on input competitor data 308, other supply chain data 310 and social data such as comments available from social media, blogs, and review data 312. For example, demand model parameters are determined to create a demand model. A channel-location, e.g., may comprise a physical store and one or more segmented online stores mapped to the location of the physical store. At a minimum, a channel-location may comprise a virtual store. Data shown at 308, 310, and 312 may be stored in storage devices and made available for demand model estimation. For example, demand may depend on various attributes such as price, promotion, seasonality, week, holiday, advertisements, and others. These attributes may be obtained from TLOG data 304 (e.g., price, holiday, week) or estimated (e.g., seasonality) based on the data of 308, 310 312, and are input to the demand estimation problem.

The estimated demand model at 306 may output a list of products that are candidates for integrated price optimization at 314. Determination of the candidate list of products in one embodiment is based on elasticity determined as a function of the estimated demand model, e.g., resulting coefficient estimated for an attribute used in the demand model.

At 316, an integrated omni-channel price optimization model is estimated that outputs optimized prices in different channels and stores 318.

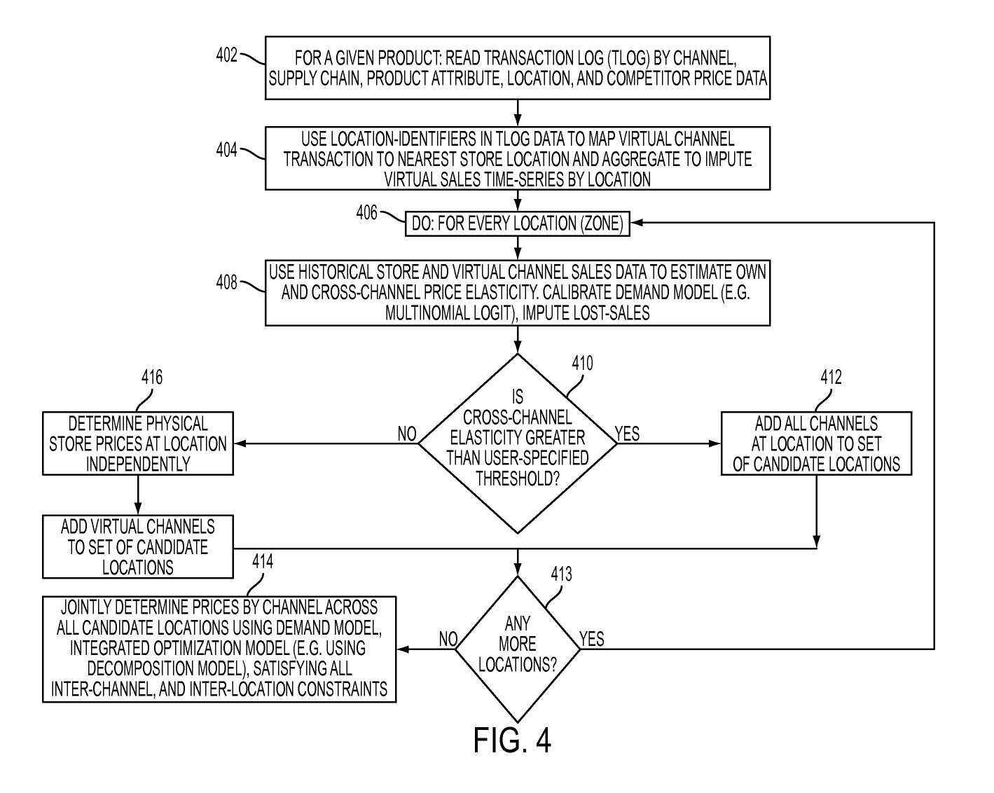

FIG. 4 is another flow diagram illustrating a method of omni-channel pricing optimization in one embodiment of the present disclosure. The method shown in FIG. 4 may be performed for a given product. At 402, for a given product, transaction log data is read by channel, and supply chain, product attribute, location, and competitor price data information is obtained or received. At 404, location identifiers in the transaction log data may be utilized to map virtual channel transaction (e.g., online transaction) to nearest physical store location. The mapped data is aggregated to obtain a virtual sales time-series by location. Thus, e.g., a mapped virtual store channel acts as or represents another store/channel associated with that location.

At 406, the processing at 408, 410, 412 and 416 are performed for every location. The processing at 414 is performed jointly across all locations. At 408, historical and virtual channel sales data is used to estimate the location's own and cross-channel price elasticity, e.g., effect of change in price in channel of the channel-location by a change in another channel of the same channel-location, for example, percentage change in sales in own channel-location and cross-channel location to one percentage change in price at a channel-location. To determine the elasticity, a demand model is calibrated and lost-sales is imputed (see e.g., below description of demand modeling), e.g., the demand model parameters are estimated. At 410, it is determined as to whether the cross-channel elasticity is greater than a user-specified threshold (see e.g., below description of identifying candidate products for integrated price optimization). If not, at 416, physical store prices at this location is determined independently. If the cross-channel elasticity is greater than user-specified threshold, at 412, the location is added to a set of candidate locations. At 413, if there are more locations, the logic of the processing returns to 406 to repeat the processing at 408, 410, 412 and 416. If there are no more locations to process, the logic of the processing proceeds to 414.

At 414, prices are jointly determined by channel across all candidate locations using a demand model, an integrated optimization model (e.g., using decomposition model), satisfying all inter-channel, and inter-location constraints.

In one aspect, the integrated optimization model computes one or more prices for each product-virtual channel pair and one price for each product-location pair in the other channels while also satisfying a plurality of inter-channel and inter-locations constraints. For example, all virtual channels see a common price across locations and all physical store channels see a location specific price.

The following paragraphs describe an embodiment of a demand model, e.g., referred to at 408 in FIG. 4 and also at 306 in FIG. 3.

Demand Model

Consider an omni-channel retailer operating in M channels, V of which are virtual channels, and J physical locations. Let Zⱼₘ be the vector of demand attributes (e.g., price, promotion, seasonality) for an product sold in channel mεM and location jεJ and Zⱼ=[Zⱼ₁, Zⱼ₂, . . . , Z_{j|M|}] be the corresponding matrix of attributes in all channels at location j. Here |.| refers to cardinality of a set. Let Dₘⱼ(Zⱼ) be the demand in channel mεM originating from location jεJ. In one embodiment of a methodology of the present disclosure, it is assumed that demand in a specific channel and location depends only on attributes in that location but allow it to depend on attributes in other channels so as to account for cross-channel interactions in the omni-channel world. Let Dⱼ(Zⱼ)=[Dⱼ₁(Zⱼ), Dⱼ₂(Zⱼ), . . . , D_{j|M|}(Zⱼ)]^{T} be the vector of demands originating from location jεJ in all the channels. This is referred to as the omni-channel demand model.

In deciding the specific class of the demand model, one has a multiple alternatives depending on the features it captures as well as the ease of estimation. An embodiment discussed below are the attraction demand models. They are one of the commonly used demand functions to model consumer choice in marketing, economics and more recently in revenue management literature. They generalize the well-known multinomial logit (MNL) and the multiplicative competitive interaction (MCI) demand models. Other alternatives to demand models may include some of the following options: (a) the nested attraction demand models that generalize of attraction demand models to handle the independence of irrelevant alternatives (IIA) assumption; (b) the scan-pro demand models that explicitly capture pair-wise cross elasticities including complementary effects; (c) the hybrid demand model that combines the scan pro for market size and attraction demand model for market share.

In one embodiment of the present disclosure, these attraction demand models are used to model the channel purchase choice of a consumer in an omni-channel environment. In particular, it is assumed it has the following form:

$$\begin{matrix}{D}_{mj} ( {Z}_{j} ) = MarketSize of location j * MarketShare of channel m in location j & ( 1 ) \\ = τ \frac{f}{1 + {\sum }_{{m}^{′} ∈ M} {f}_{{m}^{′} j} ( {Z}_{{m}^{′} j} )} & ( 2 )\end{matrix}$$

where τⱼ is the market size of location j and fₘⱼ(Zₘⱼ) is the attraction function of customers in location j to channel m. Some examples of these attraction functions are fₘⱼ(Zₘⱼ)=e^{a}^{ₘⱼ}^{+b}^{ₘⱼ}^{^{T}}^{z}^{ₘⱼ} in the case of the MNL demand model and fₘⱼ (Zₘⱼ)=aₘⱼΠᵢZₘⱼᵢ^{b}^{ₘⱼᵢ} in the case of the MCI demand model.

In the above demand model, based on historic sales data and attributes of a product, Zₘⱼ, in all channels mεM and locations jεJ, demand Dₘⱼ(Zⱼ), for a product sold in channel mεM and location jεJ, market size of location j, τⱼ product are estimated. This involves estimating parameters, e.g., a, b in the above examples, for every attribute.

An attraction demand model is often chosen in practice to model choice because it has fewer coefficients to evaluate than its counterparts such as the pure additive, exponential or power models. In particular, the number of coefficients in the attraction demand model is O(K) for K choices as opposed to O(K²) in the other models such as a scan-pro (linear, exponential or power) demand model.

To estimate this demand function, historical sales data originating from each channel in every location jεJ is used. In particular in one embodiment, virtual sales data is always tagged with zipcode information and is used to partition the sales data in this estimation procedure. Even with all the sales information, estimating an attraction demand model from sales data is not all that straightforward because the attraction model also requires the knowledge of the lost sales component which is mathematically:

$${τ}_{j} \frac{1}{1 + {\sum }_{{m}^{′} ∈ M} {f}_{{m}^{′} j} ( {p}_{{m}^{′} j} )} .$$

Lost sales is unknown in many applications but methods like Expectation-Maximization (EM) technique or the 2-step approach have been proposed and used in practice to overcome this challenge. In both these methods the attraction model is itself fitted based on a maximum-likelihood approach.

Once the parameters for the demand model are estimated, the vector of demands originating from location jεJ in all the channels, Dⱼ(Zⱼ), may be determined for location j.

The following paragraphs describe identifying candidate products for integrated price optimization, e.g., referred to at 410 in FIG. 4 and also at 314 in FIG. 3.

Identifying Candidate Products for Integrated Price Optimization

In this section, a method in one embodiment to identify the list of candidate products that exhibit cross-channel price interactions is described. Cross-channel price interactions motivate the need for integrated pricing decisions across the retail chain. Let pⱼ=[p₁ⱼ, p₂ⱼ, . . . , p_{|M|j}]^{T} be the vector of prices that the retailer offers for an product in all channels at a location jεJ and Dⱼ(pⱼ) be the corresponding vector of demands. Note that pⱼ is one of the attributes in Zⱼ of the demand model described above. For making or computing pricing decisions, it may be assumed that all the other attributes are fixed and given. This implies that demand is a function of only prices from this section forward. Using the estimated omni-channel demand model the cross-channel price elasticities (e.g., εₘ_{₁}ₘ_{₂}ⱼ below) may be computed for each location as follows in one embodiment:

$${ɛ}_{{m}_{1} {m}_{2} j} = \frac{\partial {D}_{{m}_{1} j} ( {p}_{j} )}{\partial {p}_{{m}_{2} j}} \frac{{p}_{{m}_{2} j}}{{D}_{{m}_{1} j} ( {p}_{j} ) } ∀ {m}_{1} , {m}_{2} ∈ M . \qquad ( 3 )$$

This number (εₘ_{₁}ₘ_{₂}ⱼ) provides the expected percentage increase in demand in channel m₁, if the price in the other (or same) channel, m₂, is increased by one percent. For example, the percentage increase in brick-and-mortar demand for a product at a store location, if the online (internet) price of the same product is increased by one percent. If m₁=m₂, the well-known own channel price-elasticity coefficients may be obtained. They are non-positive numbers. On the other hand, if m₁≠m₂, cross-elasticities, an aspect in the omni-channel environment of the present disclosure may be obtained. These cross elasticities are non-negative numbers. Note that cross-elasticities are calculated for each channel pair (e.g., impact of store price on online sales, and online price on store sales).

In one embodiment of the present disclosure, a threshold-based logic may be adopted to identify whether integrated pricing decisions are needed, i.e., if the prices recommended in the various channels at the location have be decided (e.g., optimized) simultaneously taking into account the effects of cross-channel price interactions, if any. If all cross-elasticity values at a location are less than a user-specified threshold (e.g., 0.001), the methodology of the present disclosure in one embodiment may conclude that the cross-channel effects for the particular product is insignificant, and that such a product-location combination is not a candidate for integrated price optimization at that location.

Cross-elasticity computations for an MNL attraction demand model:

The MNL demand model has the following form:

$${D}_{mj} ( {p}_{j} ) = {τ}_{j} \frac{{f}_{mj} ( {p}_{mj} )}{1 + {\sum }_{{m}^{′} ∈ M} {f}_{{m}^{′} j} ( {p}_{{m}^{′} j} )} \\ where \\ {f}_{mj} ( {p}_{mj} ) = {e}^{{a}_{mj} - {b}_{mj} {p}_{mj}} ∀ m ∈ M , j ∈ J \qquad ( 4 )$$

Own-channel price elasticity are

$${ɛ}_{mmj} = - {b}_{mj} {p}_{mj} [ 1 - \frac{{f}_{mj} ( {p}_{mj} )}{1 + {\sum }_{{m}^{′} ∈ M} {f}_{{m}^{′} j} ( {p}_{{m}^{′} j} )} ] \qquad ( 5 )$$

Cross-channel price elasticity are

$${ɛ}_{{mm}^{′} j} = {b}_{{m}^{′} j} {p}_{{m}^{′} j} \frac{{f}_{{m}^{′} j} ( {p}_{{m}^{′} j} )}{1 + {\sum }_{{m}^{″} ∈ M} {f}_{{m}^{″} j} ( {p}_{{m}^{″} j} )} \qquad ( 6 )$$

The following paragraphs describe an embodiment of a price optimization model for a single basic product, referred to at 414 and 416 in FIG. 4 and also at 316 in FIG. 3.

Price Optimization Model for a Single Basic Product

An omni-channel price optimization model may be formulated to identify the most profitable prices in all channels and locations subject to various business rules. The formulation in one embodiment aims to exploit cross channel price interactions using the framework described with reference to FIG. 1. A business rule that is considered in the omni-channel environment that requires an integrated optimization across locations may include offering uniform prices across all locations in all virtual channels such as online stores.

Let pⱼ be the vector of prices that the retailer offers for the product in all channels at a location jεJ and let cⱼ be the associated vector of costs. Let Dⱼ(pⱼ) be the vector of demands originating from location jεJ in all the channels. It may be assumed that demand in a specific channel and location depends only on prices offered in that location but allow it to depend on prices offered in other channels so as to account for cross-channel price interactions in the omni-channel world.

The analysis may pertain to the class of basic products where it is assumed that there are well established replenishment policies and that out-of-stock inventory effects are minimal or non-existent across the retail chain. This is a very reasonable assumption for basic products. Mathematically, it allows to view the integrated pricing problem as a single period pricing problem. The general non-linear omni-channel price optimization problem denoted by OCP may be formulated as follows:

$$\begin{matrix}OCP \text{:} {max}_{{p}_{j}} {\sum }_{j ∈ J} {( {p}_{j} - {c}_{j} )}^{T} {D}_{j} ( {p}_{j} ) & ( 7 ) \\ {\sum }_{j} {A}_{kj} {D}_{j} ( {p}_{j} ) \leq {u}_{k} ∀ k = 1 , … , K & ( 8 ) \\ {\sum }_{j} {B}_{ij} {p}_{j} \leq {v}_{l} ∀ l = 1 , … , L & ( 9 ) \\ {p}_{m , j} = {p}_{m , {j}^{′}} ∀ m ∈ V , j , {j}^{′} ∈ J & ( 10 ) \\ {p}_{mj} ∈ {Ω}_{mj} ∀ m ∈ M , j ∈ J . & ( 11 )\end{matrix}$$

The decision variables in the above formulation are the prices in all locations and channels and the objective is to maximize the total profitability of the retailer across the retail chain. Volume constraints of Equation (8) and PriceConstraints of Equation (11) are generic constraints on demand and prices defined with known vectors uεR^{K}, vεR^{L}. Examples of these constraints are provided below. The online price constraint of Equation (10) that enforces the same price across virtual stores is explicitly called out. This constraint is particularly relevant within the omni-channel framework of the present disclosure because the virtual channels are partitioned by location to model cross-channel effects by location and this constraint binds them back together from the view of the customer. Discrete pricing constraints, if present, are encapsulated in price constraint of Equation (11). Some examples of the generic business rules (8) and (11) used in practice are as follows:

$$Volume ( or sales goal ) constraints \\ {\sum }_{m ∈ {M}_{k} , j ∈ {J}_{k}} {D}_{mj} ( {p}_{j} ) \geq {u}_{k} , \qquad ( 12 )$$

where Mₖ⊂M and Jₖ⊂J and depending on the choice of Mₖ, Jₖ these constraints can be treated as sales goals by channel, location or system wide. These constraints ensure that the total sales by channel, for example, does not drop more than a threshold, uₖ, which is usually determined with historical sales values. These constraints aim to introduce a balance between profitability and market share objectives of a retailer. They also help in stabilizing the price recommendations to avoid drastic price increase when price elasticity estimated from data turns out to be very small.

Price Monotonicity Constraints

pₘⱼ≦p_{m′j}+v_{mm′j}∇jεJ and for some m,m′εM. (13)

The goal of this constraint is to guarantee that purchasing in certain channels are cheaper than others by a specified constant. This is often done to account for costs that are unspecified to the pricing problem such as the overhead costs of operating a large store. An extension of this constraint is the price matching constraints across the retail chain where the inequality is replaced by a equality and v_{mm′j}=0. Some retailers view a price matching constraint as the future of omni-channel retailing where consumers can buy the same product any where in the retail chain at the same price while many others do not.

Price Bounds

bₘⱼ≦pₘⱼ≦ b̅ₘⱼ∇jεJ,∇mεM. (14)

Here, bₘⱼ and b̅ₘⱼ are upper and lower bounds that are often imposed as a percentage of historically offered prices to ensure validity of the estimated demand model or as a percentage of competitor prices to ensure the competitiveness of the retailer.

Discrete Prices

pₘⱼεΩₘⱼ∇jεJ,∇mεM. (15)

Magic number endings (e.g., those ending with 9) are considered important to a retailer and are encoded in this business rule. When retailer re-optimize prices, these rules avoid taking very small unnecessary price changes.

In practice the choice of the business rules differ by product category and by the retailer. But generally all the constraints in the problem may be classified as either inter-channel or inter-location constraints depending on whether a constraint involves different channels or different locations. A methodology of the present disclosure in one embodiment treats constraints on a specific channel-location pair as a subclass of inter-channel constraints and constraints that are both inter-channel and inter-location as inter-location constraints.

Methods to Solve the Price Optimization Problem

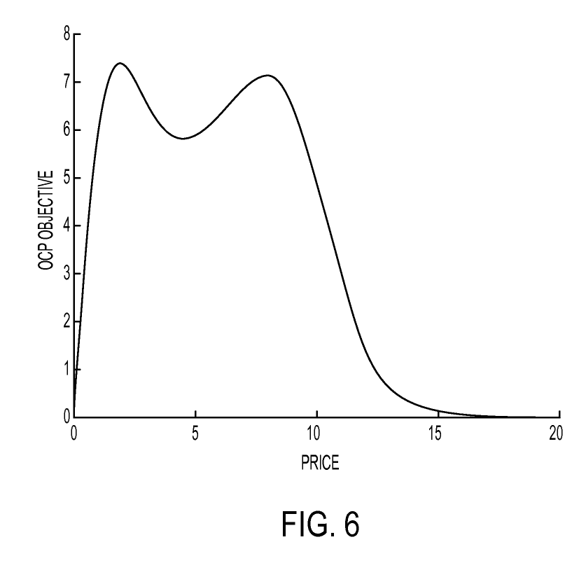

The integrated price optimization problem OCP described above is a highly non-linear and non-convex problem. For example, FIG. 6 shows a plot of an instance of the OCP objective with attraction demand models for the case of a single virtual channel, say online, and two locations. FIG. 6 shows OCP objective for a single virtual channel, say online, and two locations as a function of the online price for an MNL attraction demand model with a₁₁=10, a₁₂=1, b₁₁=1, b₁₂=1, τ₁=1 and τ₂=10. Constraint of Equation (10) (same online price) is the only constraint in this example. It is observed that the OCP objective is non-convex and has multiple peaks. The main challenge using an off the shelf non-linear solver is the use of gradient based methods that result in a local optima which can be far away from the global optimum of the problem resulting in poor quality pricing recommendations. The challenge with a straightforward enumeration is that the problem is computationally intractable to solve. In this section, two tractable methods are provided that can achieve the global optimum to the OCP problem. These methods exploit the structure of the problem and/or the structure of the attraction demand model and/or the discreteness of the prices offered.

Decomposition Method for the Case of the Brick and Online Channel

In the two channel case, a decomposition algorithm to the OCP with discretized brick and online prices for any omni-channel demand model may be as follows: fix the online price and solve the corresponding brick problems to optimality and search over all online prices.

Given an online price, the brick problems are no longer inter-linked to each other except through certain inter-location constraints, if any. In the absence of inter-location constraints, the brick problems are solved separately to optimality. The run time in the presence of discrete online and brick and mortar store prices is O(|J|*|I|) where the set I denotes the set of discrete prices and |.| represents the size of the set. Note that currently retailers solve single channel and single location problems and hence those techniques can be adopted. If there are inter-location constraints, one of two approaches may be adopted in practice:

1. All feasible brick prices for each location corresponding to the online price and its corresponding contributions to constraints and objective is included in a master problem. The master problem is maximizing a the total profit subject to the inter-linking constraints only. This has a knapsack like structure because of the discrete nature of brick prices. The feasible brick prices correspond to binary variables in the master problem. The master problem is then solved to optimality to give the optimal solution at the corresponding online price. The run time in the presence of discrete online and brick prices is O(|J|*|I|²*V) where V is the size of the capacity in the knacpsack constraint.
2. A dynamic column generation method is adopted when the number of locations and feasible prices are relatively large. Here a restricted master problem is gradually built instead of one shot (as in the above case) and with much fewer brick pricing binary variables. The sub-problems are the individual brick problems with a dual variable penalties for the relaxed inter-linking constraints. A branch and price approach is adopted to solve the problem to optimality.

These decomposition methods are highly beneficial when there are a lot of inter-channel constraints because they can all be handled locally for each brick problem given an online price. For the case of an attraction demand model a methodology of the present disclosure can exploit the structure of the subproblems to speed-up the run times to a large degree, in fact solve the brick and mortar store problems to near-closed form. This is described in the following section.

Attraction Demand Models

Consider the OCP problem with constraint of Equation (10) (same online price) and inter-channel constraints only. A study of the more general case with inter-location constraints are also described below. Given an online price pₒ, the OCP problem decomposes by brick locations. This means if Π(pₒ) denotes the optimal objective of the corresponding OCP with online price pₒ then

$$Π ( {p}_{o} ) = {\sum }_{j ∈ J} {τ}_{j} {Π}_{j} ( {p}_{o} ) \qquad ( 16 )$$

where Πⱼ (pₒ) is the optimal objective of the corresponding OCP at location j. The present disclosure denotes this problem as OCPⱼ(pₒ). The only decision variable in this location specific OCP is the brick price denoted by p_{bj}. It may be assumed that all the inter-channel constraints given pₒ at a location encompass a convex feasible region in the brick price. All the constraints described above in Equations (8)-(11) satisfy this criterion except the discrete price constraint. It is seen that discrete pricing constraints are not hard to impose as described below. Therefore, given pₒ, all the inter-channel constraints are reduced to lower and upper bound on the scalar variable p_{bj} denoted by h(pₒ) and h̅(pₒ) respectively. The problem OCPⱼ(pₒ) takes the following form:

$$\begin{matrix}{OCP}_{j} ( {p}_{o} ) \text{:} {Π}_{j} ( {p}_{o} ) = {max}_{{p}_{bj}} {\sum }_{m ∈ \{ o , b \}} ( {p}_{mj} - {c}_{mj} ) \frac{{f}_{mj} ( {p}_{mj} )}{1 + {f}_{bj} ( {p}_{bj} ) + {f}_{oj} ( {p}_{o} )} & ( 17 ) \\ s . t . \\ {\underline{h}}_{j} ( {p}_{o} ) \leq {p}_{bj} \leq {\overline{h}}_{j} ( {p}_{o} ) & ( 18 )\end{matrix}$$

The following assumptions are made under which Πⱼ(pₒ) is obtained in near closed form.

Assumption 1. The attraction function, fₘⱼ: R→R⁺ for each channel mεM and location jεJ and satisfies:

1. fₘⱼ(.) is strictly decreasing and is twice differentiable on R, and
2. lim_{x→-∞}fₘⱼ(x)=∞, and lim_{x→∞}fₘⱼ(x)=0.

This is a very mild assumption of the structure of the demand model.

Assumption 2. The function gₘⱼ(.)=fₘⱼ⁻¹(.) satisfies the following condition for all mεM and jεJ:

2g′ₘⱼ(y)+yg″ₘⱼ(y)≦0 ∇y>0. (19)

A known method showed that under the above general condition the pricing objective for multi-product (equivalently, single location multi-channel) attraction demand models (as in Πⱼ (pₒ), the objective of OCPⱼ(pₒ)) in a transformed market share space is a concave function. The well know MNL, MCI and linear attraction demand models satisfy this assumption. Note that Πⱼ (pₒ) is not a concave function, let alone a quasi-concave function, in the price space but is uni-modal.

It is also noted that the objective of original OCP problem, Π(pₒ), in the presence of the price-monotonicity constraints or constraint of Equation (10) (same online price) is a non-convex function both in the price space and the transformed space (see e.g., FIG. 6). In this section, the present disclosure uses the ideas of the result that show the computational efficiency of the OCP for each separate location to construct the results for the original OCP problem.

The optimal objective of the location specific OCP with inter-channel constraints and continuous brick price given the online price pₒ for any location jεJ, denoted by OCPⱼ(pₒ) is simplified as follows under assumption 2

$${Π}_{j} ( {p}_{o} ) = \{ \begin{matrix}{Z}_{j} ( {p}_{o} , \underline{h} ( {p}_{o} ) ) & {p}_{bj}^{*} \leq {\underline{h}}_{j} ( {p}_{o } ) \\ ( {p}_{o} - {c}_{o} ) \frac{{f}_{oj} ( {p}_{o} )}{1 + {f}_{oj} ( {p}_{o} )} + {H}_{j} ( {p}_{o} , {p}_{bj}^{*} ) & {\underline{h}}_{j} ( {p}_{o} ) < {p}_{bj}^{*} < {\overline{h}}_{j} ( {p}_{o} ) \\ {Z}_{j} ( {p}_{o} , \overline{h} ( {p}_{o} ) ) & otherwise .\end{matrix} \qquad ( 20 )$$

where Zⱼ(pₒ, p_{bj}) is the objective of OCPⱼ(pₒ) with online price pₒ and brick price p_{bj},

$${p}_{bj}^{*} = {g}_{bj} ( z ) , \\ {g}_{bj} ( . ) = {f}_{bj}^{- 1} ( . ) , \\ {H}_{j} ( {p}_{o} , {p}_{bj}^{*} ) = - \frac{{z}^{2}}{1 + {f}_{oj} ( {p}_{o} )} {g}_{bj}^{′} ( z ) = - \frac{{f}_{bj}^{2} ( {p}_{bj}^{*} )}{1 + {f}_{oj} ( {p}_{o} )} \frac{1}{{f}_{bj}^{′} ( {p}_{bj}^{*} )}$$

and z is the solution of the differential equation:

$${g}_{bj} ( z ) + z ( 1 + \frac{z}{1 + {f}_{oj} ( {p}_{o} )} ) {g}_{bj}^{′} ( z ) = {C}_{j} {=}^{def} ( {p}_{o} - {c}_{o} ) \frac{{f}_{oj} ( {p}_{o} )}{1 + {f}_{oj} ( {p}_{o} )} + {c}_{bj} . \qquad ( 21 )$$

Alternatively, in the price space, the differential equation is:

$${p}_{bj}^{*} + {f}_{bj} ( {p}_{bj}^{*} ) ( 1 + \frac{{f}_{bj} ( {p}_{bj}^{*} )}{1 + {f}_{oj} ( {p}_{o} )} ) \frac{1}{{f}_{bj}^{′} ( {p}_{bj}^{*} )} = {C}_{j} {=}^{def} ( {p}_{o} - {c}_{o} ) \frac{{f}_{oj} ( {p}_{o} )}{1 + {f}_{oj} ( {p}_{o} )} + {c}_{bj} . \qquad ( 22 )$$

In particular, for an MNL demand function,

$${H}_{j} ( {p}_{o} , {p}_{bj}^{*} ) = \frac{z}{1 + {f}_{oj} ( {p}_{o} )}$$

and the differential equation simplifies to

$$log z + \frac{z}{1 + {f}_{oj} ( {p}_{o} )} = {a}_{bj} - 1 - {b}_{bj} {C}_{j} . \qquad ( 23 )$$

It is noted that the left-hand side (LHS) of the above differential equations are non-increasing functions and therefore the differential equations always have a solution.

In order to find the optimal online price, pₒ*=argmaxₚ_{ₒ}Π(pₒ)=argmaxₚ_{ₒ}Σ_{jεJ}τⱼΠⱼ(pₒ), that solves the OCP, a methodology of the present disclosure may search over every discretized online price point with the near-closed form solution described above for each location jεJ. Note that in FIG. 6, it is observed that this function is non-convex and can have multiple peaks. This is the reason every single feasible online price point has to be scanned. The algorithm therefore is polynomial in the number of discrete online prices i.e., O(|I|) where |I| is number of discrete online prices.

The extension to the case of discrete brick prices is straightforward. Each subproblem by location given pₒ is a concave maximization problem in a market share space. Therefore, a simple rounding algorithm around the maximum that checks both the upper and lower bounds within the feasible region is implemented.

In the presence of inter-location constraints, a methodology of the present disclosure in one embodiment may adopt a branch and price method described above. The structure of the subproblems do not change significantly because additionally there are some dual penalties terms in the objective related to the relaxed inter-location constraint. This modified subproblem has a very similar structure to the original problem in that the computational gain comes in being able to solve the sub-problems in near closed form as described above.

Mixed-Integer Programming Approach for the Multi-Channel Case with Attraction Demand Models

A known methodology provides a mixed-integer linear programming formulation of multi-product problem for a hybrid MNL demand model with many practical business rules. In a hybrid demand model, the market size is piece-wise linear function of price and captures the lost sales component and the market share is similar to an MNL demand model without the constant 1 in the denominator. That methodology employ a market share transformation to linearize the problem and simultaneously work in a price and market share space to impose the business rules. A methodology in the present disclosure in one embodiment may adopt a similar solution approach in the present disclosure's setting but for the case of a pure attraction demand model in the omni-channel setting.

Let the feasible discrete prices for each channel mεM and location jεJ be denoted by pₘⱼᵢεIₘⱼ where the set Iₘⱼ denotes the list of feasible prices. Note that for a virtual channel vεV⊂M, prices across all locations are the same. In this case, denote the prices by p̅ᵥᵢεIᵥ. Here Iᵥ=Iᵥ∇jεJ. Let qₘⱼᵢ=τⱼ( p̅ₘⱼᵢ−cₘⱼ)fₘⱼ( p̅ₘⱼᵢ) and rₘⱼᵢ=fₘⱼ( p̅ₘⱼᵢ). The price optimization problem is reduced to the following form.

$$\begin{matrix}{max}_{{z}_{mji} , {z}_{vi}} {\sum }_{j ∈ J} \frac{{\sum }_{m ∈ M \backslash V , i ∈ {I}_{mj}} {q}_{mji} {z}_{mji} + {\sum }_{v ∈ V , i ∈ {I}_{v}} {q}_{vji} {z}_{vi}}{1 + {\sum }_{m ∈ M \backslash V , i ∈ {I}_{mj}} {r}_{mji} {z}_{mji} + {\sum }_{v ∈ V , i ∈ {I}_{v}} {r}_{vji} {z}_{vi}} & ( 24 ) \\ {\sum }_{m ∈ M \backslash V , j ∈ J , i ∈ {I}_{mj}} {a}_{mjik} {z}_{mji} + {\sum }_{v ∈ V , j ∈ J , i ∈ {I}_{v}} {a}_{vjik} {z}_{vi} \leq {u}_{k} ∀ k ∈ K & ( 25 ) \\ {\sum }_{i ∈ {I}_{mj}} {z}_{mji} = 1 ∀ j ∈ J , m ∈ M \backslash V & ( 26 ) \\ {\sum }_{i ∈ {I}_{v}} {z}_{vi} = 1 ∀ v ∈ V & ( 27 ) \\ {z}_{mji} ∈ \{ 0 , 1 \} ∀ i ∈ {I}_{mj} , m ∈ M \backslash V , j ∈ J & ( 28 ) \\ {z}_{vi} ∈ \{ 0 , 1 \} ∀ i ∈ {I}_{v} , v ∈ V & ( 29 )\end{matrix}$$

In the above formulation all the inter-channel and inter-location constraints are summarized by constraint of Equation (32) (business rules), and are indexed by kεK. This formulation is not a linear formulation and so the methodolgoy of the present disclosure in one embodiment may proceed with the following steps to linearize it.

Let yⱼ=[1+Σ_{mεM\V,iεI}_{ₘⱼ}rₘⱼᵢzₘⱼᵢ+Σ_{vεV,iεI}_{ᵥ}rᵥⱼᵢzᵥᵢ]⁻¹∇jεJ. Define yⱼzₘⱼᵢ=xₘⱼᵢ and yⱼzᵥᵢ=xᵥⱼᵢ. Since 0≦yⱼ≦1∇jεJ, 0≦xₘⱼᵢ≦1∇mεM, iεIₘⱼ.

$$\begin{matrix}{max}_{{z}_{bji} , {z}_{oi} , {x}_{mji}} {\sum }_{j ∈ J , m ∈ M , i ∈ {I}_{mj}} {q}_{mji} {x}_{mji} & ( 30 ) \\ {y}_{j} + {\sum }_{m ∈ M , i ∈ {I}_{mj}} {r}_{mji} {x}_{mji} = 1 ∀ j ∈ J & ( 31 ) \\ {\sum }_{m ∈ M \backslash V , j ∈ J , i ∈ {I}_{mj}} {a}_{mjik} {z}_{mji} + {\sum }_{v ∈ V , j ∈ J , i ∈ {I}_{v}} {a}_{vjik} {z}_{vi} \leq {u}_{k} ∀ k ∈ K & ( 32 ) \\ {x}_{mji} \leq {y}_{j} ∀ i ∈ {I}_{mj} , m ∈ M , j ∈ J & ( 33 ) \\ {\sum }_{i ∈ {I}_{mj}} {x}_{mji} \leq {y}_{j} ∀ m ∈ M , j ∈ J & ( 34 ) \\ {x}_{mji} \leq {z}_{mji} ∀ i ∈ {I}_{mj} , m ∈ M \backslash V , j ∈ J & ( 35 ) \\ {x}_{vji} \leq {z}_{vi} ∀ i ∈ {I}_{mj} , v ∈ V , j ∈ J & ( 36 ) \\ {x}_{mji} \geq 0 ∀ i ∈ {I}_{mj} , m ∈ M , j ∈ J & ( 37 ) \\ {\sum }_{i ∈ {I}_{mj}} {z}_{mji} = 1 ∀ j ∈ J , m ∈ M \backslash V & ( 38 ) \\ {\sum }_{i ∈ {I}_{v}} {z}_{vi} = 1 ∀ v ∈ V & ( 39 ) \\ {z}_{mji} ∈ \{ 0 , 1 \} ∀ i ∈ {I}_{mj} , m ∈ M \backslash V , j ∈ J & ( 40 ) \\ {z}_{vi} ∈ \{ 0 , 1 \} ∀ i ∈ {I}_{v} , v ∈ V & ( 41 )\end{matrix}$$

The above formulation is now a linear mixed integer program (MIP) and any off the shelf MIP solver like CPLEX or Gurobi can solve this problem to optimality. Constraint of Equation (34) are the RLT constraints and achieves the same goal as the prior constraint. But it may be observed that they strengthen the formulation considerably resulting in considerable speed up in run times and hence include them as a part of the formulation.

Extended Applications of the Price Optimization Problem

The following illustrates two practical applications of the price optimization problem that are useful in practice in retail aside from the direct omni-channel optimization described above.

Multi-Period Base Price Optimization:

The pricing problems sometimes require a multi-period treatment in practice even in the absence of inventory effects because the retailer aims to set a constant base (regular or ticket) price for the product over a horizon and use promotional tactics to alter prices in near term. Note that in these scenarios the demand is still estimated every period because of the forecasting reports that are generated at the end of the optimization. The price optimization model is modified to include all periods in one problem along with a constraint similar to constraint of Equation (10) (same online price) across time. Here the general decomposition method by channel (decomposition method described above) and the MIP based method (mixed-integer programming approach for the multi-channel case with attraction demand models) is employed in this setting.

Asynchronous Channel-Specific Optimization:

It is easy to change the online prices but much harder to change brick prices. Therefore an asynchronous channel-specific optimization may be needed. For example, solve brick and online jointly every few weeks but during the interim period fix the brick prices and solve online more frequently (example, daily or bi-weekly or weekly). This is just a special case of the methods described above where the feasible space for one channel is precisely one point.

As described above, an aspect of the present disclosure computes location based elasticities (e.g., own and cross-channel for all channels) by imputing and partitioning the sales into virtual channel-locations. This enables the construction of demand models at the location-channel level which are in turn embedded within the integrated price optimization solution. The integrated price optimization may solve for all locations jointly through one optimization problem.

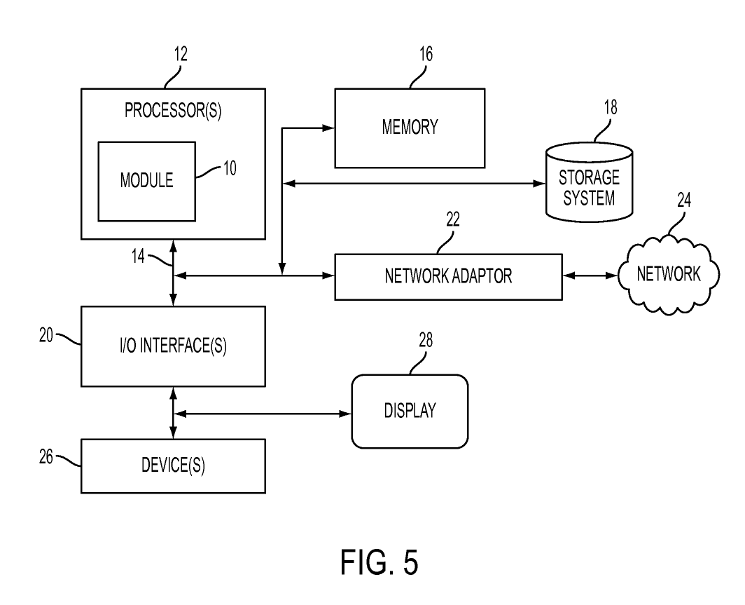

FIG. 5 illustrates a schematic of an example computer or processing system that may implement a demand modeling and price optimization system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 5 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method of predicting demand of a product offered in multiple channels for a seller that has a plurality of physical store channels and one or more virtual channels, comprising:
obtaining, by a processor, transaction log data associated with the one or more virtual channels, the transaction log data having records of sales transactions with location identifiers in the one or more virtual channels;
segmenting, by the processor, the one or more virtual channels by locations based on locations of the physical stores and the location identifiers in the transaction log data; and
estimating, by the processor, a demand model by location that incorporates demand for the multiple channels in that location and captures cross-effect of said multiple channels in the location based on historic sales and transaction data, the location being one of the locations.

2. The method of claim 1, further comprising:
computing cross-channel elasticity between the multiple channels in the location based on the estimated demand model;
determining whether the location is a candidate for integrated price optimization based on the cross-channel elasticity; and
in response to determining that the location is a candidate for integrated price optimization, adding the location to a set of candidate locations for joint price optimization.

3. The method of claim 2, wherein said estimating a demand model, said computing cross-channel elasticity, and said determining whether the location is a candidate, are performed for every segmented location, and the method further comprises jointly determining prices for the product by channel across all candidate locations.

4. The method of claim 3, wherein the jointly determining prices comprises computing an integrated optimization model subject to inter-channel and inter-location constraints.

5. The method of claim 4, wherein the integrated optimization model computes one or more prices for each product-virtual channel pair and one price for each product-location pair in the other channels while also satisfying a plurality of inter-channel and inter-locations constraints.

6. The method of claim 1, wherein the demand model is computed as a product of market size and channel share for every location-channel pair.

7. The method of claim 1, wherein said estimating a demand model comprises estimating parameters associated with attributes of the demand model, the attributes determined at least based on competitor data, supply chain data and social media data.

8. A computer readable storage medium storing a program of instructions executable by a machine to perform a method of predicting demand of a product offered in multiple channels for a seller that has a plurality of physical store channels and one or more virtual channels, the method comprising:
obtaining, by a processor, transaction log data associated with the one or more virtual channels, the transaction log data having records of sales transactions with location identifiers in the one or more virtual channels;
segmenting, by the processor, the one or more virtual channels by locations based on locations of the physical stores and the location identifiers in the transaction log data; and
estimating, by the processor, a demand model by location that incorporates demand for the multiple channels in that location and captures cross-effect of said multiple channels in the location based on historic sales and transaction data, the location being one of the locations.

9. The computer readable storage medium of claim 8, further comprising:
computing cross-channel elasticity between the multiple channels in the location based on the estimated demand model;
determining whether the location is a candidate for integrated price optimization based on the cross-channel elasticity; and
in response to determining that the location is a candidate for integrated price optimization, adding the location to a set of candidate locations for joint price optimization.

10. The computer readable storage medium of claim 9, wherein said estimating a demand model, said computing cross-channel elasticity, and said determining whether the location is a candidate, are performed for every segmented location, and the method further comprises jointly determining prices for the product by channel across all candidate locations.

11. The computer readable storage medium of claim 10, wherein the jointly determining prices comprises computing an integrated optimization model subject to inter-channel and inter-location constraints.

12. The computer readable storage medium of claim 11, wherein the integrated optimization model computes one or more prices for each product-virtual channel pair and one price for each product-location pair in the other channels while also satisfying a plurality of inter-channel and inter-locations constraints.

13. The computer readable storage medium of claim 8, wherein the demand model is computed as a product of market size and channel share for every location-channel pair.

14. A system for predicting demand of a product offered in multiple channels for a seller that has a plurality of physical store channels and one or more virtual channels, comprising:
a processor;
memory device; and
a module operable to execute on the processor and obtain from the memory device, transaction log data associated with the one or more virtual channels, the transaction log data having records of sales transactions with location identifiers in the one or more virtual channels,
the module further operable to segment the one or more virtual channels by locations based on locations of the physical stores and the location identifiers in the transaction log data,
the module further operable to estimate a demand model by location that incorporates demand for the multiple channels in that location and captures cross-effect of said multiple channels in the location based on historic sales and transaction data, the location being one of the locations.

15. The system of claim 14, where in the module is further operable to compute cross-channel elasticity between the multiple channels in the location based on the estimated demand model, determine whether the location is a candidate for integrated price optimization based on the cross-channel elasticity, and in response to determining that the location is a candidate for integrated price optimization, add the location to a set of candidate locations for joint price optimization.

16. The system of claim 15, wherein the module estimates the demand model, computes the cross-channel elasticity, and determines whether the location is a candidate, for every segmented location, and the module further jointly determines prices for the product by channel across all candidate locations.

17. The system of claim 16, wherein the module jointly determines prices by computing an integrated optimization model subject to inter-channel and inter-location constraints.

18. The system of claim 17, wherein the integrated optimization model computes one or more prices for each product-virtual channel pair and one price for each product-location pair in the other channels while also satisfying a plurality of inter-channel and inter-locations constraints.

19. The system of claim 18, wherein the demand model is computed as a product of market size and channel share for every location-channel pair.

20. The system of claim 14, wherein the module estimates the demand model by estimating parameters associated with attributes of the demand model, the attributes determined based at least on competitor data, supply chain data and social media data.
